(19) United States
(12) Patent Application Publication
(10) Pub. No.: US 2025/0307638 A1
(43) Pub. Date: Oct. 2, 2025

(54) MESSAGE RETRY OPTIMIZATION USING SELF-LEARNING

(71) Applicant: INTERNATIONAL BUSINESS MACHINES CORPORATION, Armonk, NY (US)

(72) Inventors: Anamitra BHATTACHARYYA, Chelmsford, MA (US); Alessandro DONATELLI, Roma (IT); Dinesh C. VERMA, New Castle, NY (US); Qingyan WANG, Sudbury, MA (US); Pawan Raghunath CHOWDHARY, San Jose, CA (US)

(21) Appl. No.: 18/617,760

(22) Filed: Mar. 27, 2024

(51) Int. Cl. G06N 3/0895

(52) U.S. Cl. CPC G06N 3/0895

(57) ABSTRACT

A system, method, and computer program product that are configured to: learn dependency relationships between types of messages in a distributed computing system that utilizes message-oriented middleware; generate a dependency graph associated with a first type of message, wherein the dependency graph includes respective ones of the dependency relationships associated with the first type of message; and delay an automated retry of processing a message of the first type of message until all the dependency relationships included in the dependency graph are satisfied.

### BACKGROUND

Aspects of the present invention relate generally to message handling in computer-based messaging systems.

Message-oriented middleware (MoM) is software or hardware infrastructure supporting sending and receiving messages between distributed systems. MoM allows application modules to be distributed over heterogeneous platforms and reduces the complexity of developing applications that span multiple operating systems and network protocols. The middleware creates a distributed communications layer that insulates the application developer from the details of the various operating systems and network interfaces.

### SUMMARY

In a first aspect of the invention, there is a computer-implemented method including: learning dependency relationships between types of messages in a distributed computing system that utilizes message-oriented middleware; generating a dependency graph associated with a first type of message, wherein the dependency graph includes respective ones of the dependency relationships associated with the first type of message; and delaying an automated retry of processing a message of the first type of message until all the dependency relationships included in the dependency graph are satisfied

In another aspect of the invention, there is a computer program product including one or more computer readable storage media having program instructions collectively stored on the one or more computer readable storage media. The program instructions are executable to: learn dependency relationships between types of messages in a distributed computing system that utilizes message-oriented middleware; generate a dependency graph associated with a first type of message, wherein the dependency graph includes respective ones of the dependency relationships associated with the first type of message; and delay an automated retry of processing a message of the first type of message until all the dependency relationships included in the dependency graph are satisfied.

In another aspect of the invention, there is a system including a processor set, one or more computer readable storage media, and program instructions collectively stored on the one or more computer readable storage media. The program instructions are executable to: learn dependency relationships between types of messages in a distributed computing system that utilizes message-oriented middleware; generate a dependency graph associated with a first type of message, wherein the dependency graph includes respective ones of the dependency relationships associated with the first type of message; and delay an automated retry of processing a message of the first type of message until all the dependency relationships included in the dependency graph are satisfied.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an exemplary environment that illustrates aspects of an exemplary use case in accordance with aspects of the invention.

FIG. 4 shows a block diagram of an exemplary environment in accordance with aspects of the invention.

FIG. 5 shows a block diagram of an exemplary environment in accordance with aspects of the invention.

FIG. 6 shows a flowchart of an exemplary method in accordance with aspects of the present invention.

### DETAILED DESCRIPTION

Aspects of the present invention relate generally to message handling in computer-based messaging systems and, more specifically, to message retry optimization using self-learning. Embodiments learn dependency relationships between messages in a middleware-oriented messaging (MoM) environment and delay a retry of processing a message until all dependency relationships of the message are satisfied. In this manner, embodiments reduce the number of retry attempts for processing messages in the environment.

When a message is delivered to an application in a MoM environment, the message may have an application-level dependency on another message arriving. If the other message does not arrive prior to first message, then the application attempting to process the first message generates an error. Messages that cause an error in this manner are queued in an error queue in the MoM system and automatically retried based on a predefined time interval. For example, the MoM system may hold the message in the error queue and provide the message back to the application once every minute (or other predefined time period) so that the application may retry processing the message automatically, i.e., without human interaction or input. This time-based retry process repeats until the application successfully processes the message, which occurs in this example only after the other message arrives. Such time-based retry techniques do not take into account the dependency of the first message on the other message, and blindly repeat the retry processing at every time interval regardless of whether the other message has arrived. Accordingly, in situations where a dependency between messages is not satisfied, time-based retry techniques waste system resources by performing retry processing when there is no chance of the retry processing succeeding due to the dependency not being satisfied.

Implementations of the invention address this problem by learning dependency relationships between messages and delaying an automated retry of processing a failed message until all the dependency relationships of the failed message are satisfied. For example, embodiments may provide a computer-implemented method comprising: learning dependency relationships between types of messages in a distributed computing system that utilizes message-oriented middleware; generating a dependency graph associated with a first type of message, wherein the dependency graph includes respective ones of the dependency relationships associated with the first type of message; and delaying an automated retry of processing a message of the first type of message until all the dependency relationships included in the dependency graph are satisfied. The method reduces the expenditure of system resources by reducing the number of retry attempts when processing messages in the environment. This reduction in the expenditure of system resources constitutes an improvement in the technology of computer-based messaging systems such as middleware-oriented messaging.

In one embodiment, there is a computer-implemented method for optimizing failed message retry attempts in a Message Oriented Middleware (MoM) based distributed computing system, the method comprising: analyzing information included in message event streams and message error logs to learn dependency relationships for processing messages, wherein a dependency relationship is a relationship in which processing of a message by a computing node is dependent upon receipt of one or more additional messages by the computing node; generating a dependency graph based on the learned dependency relationships for processing messages between various computing nodes in a distributed computing system; and delaying processing of a first type of message by the computing node until all dependency relationships associated with the first type of message, as indicated by the dependency graph, are satisfied. The method reduces the expenditure of system resources by reducing the number of retry attempts when processing messages in the environment, thus providing an improvement in the technology of computer-based messaging systems such as middleware-oriented messaging. The method may further comprise learning a dependency relationship for processing the first type of message based, at least in part, on: identifying an unsuccessful attempt by the computing node to process the first type of message; identifying that a retry attempt by the computing node to process the first type of message is successful; determining whether a second type of message arrived at the computing node prior to or after the successful retry attempt to process the first type of message; and responsive to determining that the second type of message arrived at the computing node prior to the successful retry attempt to process the first type of message, creating a dependency between the first type of message and the second type of message. The dependency graph may be a directed graph, in which nodes on the directed graph are representative of messages in an event stream, and edges connecting the nodes are representative of dependencies between the messages.

Implementations of the invention are necessarily rooted in computer technology. For example, the step of delaying an automated retry of processing a message of the first type of message until all the dependency relationships included in the dependency graph are satisfied is performed in a computing system and cannot be performed in the human mind. Moreover, learning dependency relationships by generating an artificial intelligence model based on message arrival logs and message error logs in the distributed computing system is computer based and cannot be performed in the human mind. Training and using an artificial intelligence model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using an artificial intelligence model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as retry optimization code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

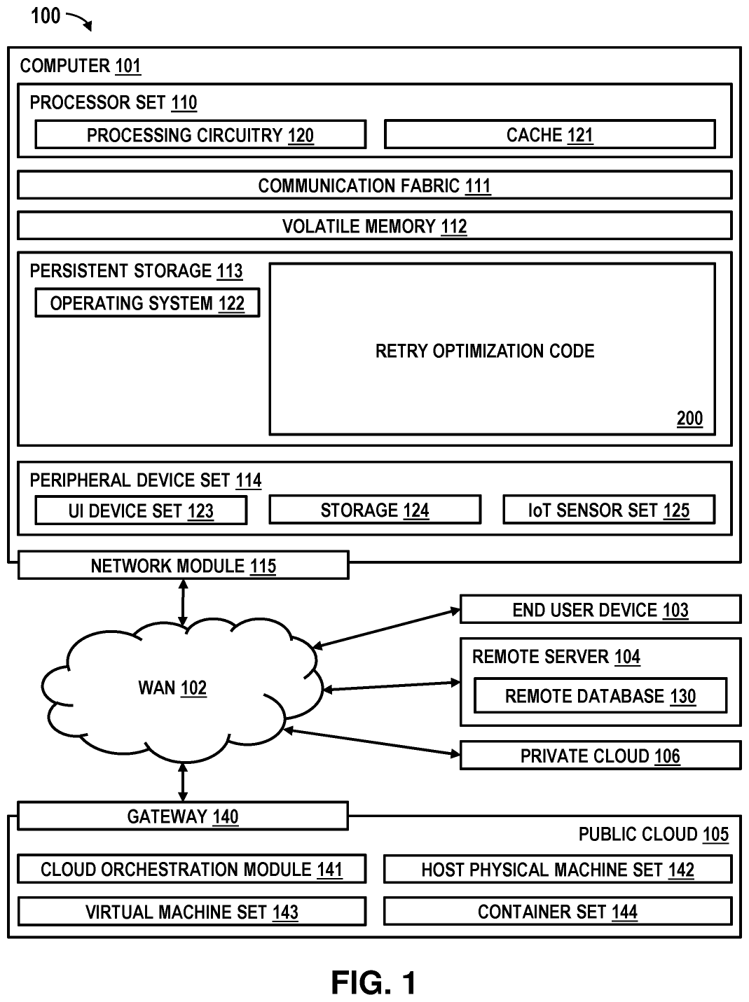

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

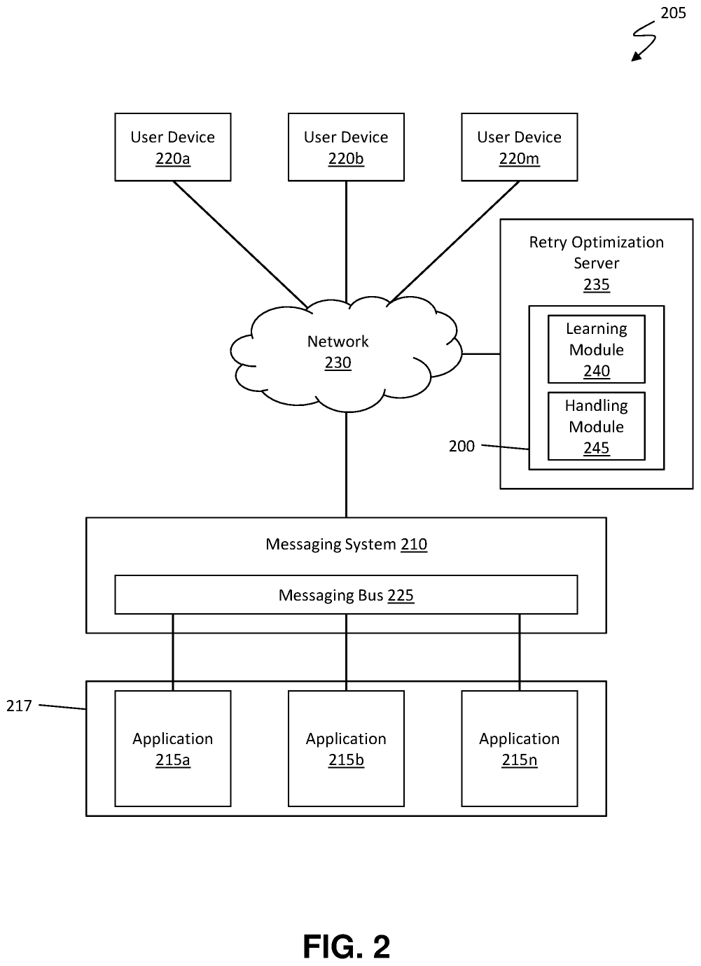

FIG. 2 shows a block diagram of an exemplary environment 205 in accordance with aspects of the invention. In embodiments, the environment 205 includes a messaging system 210, applications 215a, 215b, . . . 215n, and user devices 220a, 220b, . . . , 220m. The messaging system 210 may comprise a MoM system including a messaging bus 225 that delivers messages to and from the applications 215a-n. The applications 215a-n may comprise any plural number “n” of applications in a distributed computing system 217 and running on any number of servers, virtual machines, or containers, such as remote server 104 of FIG. 1. The user devices 220a-m may comprise any number “m” of user devices such as end user device 103 of FIG. 1. Network 230, which may comprise WAN 102 of FIG. 1, may provide communication between the elements of the environment 205.

In an embodiment, the environment 205 also includes a retry optimization server 235 that runs the retry optimization code of block 200 of FIG. 1. The retry optimization server 235 may comprise one or more instances of the computer 101 of FIG. 1, or may comprise one or more virtual machines or containers running on one or more instances of the computer 101 of FIG. 1. In embodiments, the retry optimization server 235 of FIG. 2 comprises a learning module 240 and a handling module 245, each of which may comprise modules of the retry optimization code of block 200. Such modules may include routines, programs, objects, components, logic, data structures, and so on that perform particular tasks or implement particular data types that the retry optimization code of block 200 uses to carry out the functions and/or methodologies of embodiments of the invention as described herein. These modules of the retry optimization code of block 200 are executable by the processing circuitry 120 of FIG. 1 to perform the inventive methods as described herein. The retry optimization server 235 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the learning module 240 is configured to learn dependency relationships between types of messages processed by the applications 215a-n in the distributed computing system 217, which utilizes message-oriented middleware of the messaging system 210. In embodiments, the applications 215a-n process messages received via the messaging system 210. When a first message is delivered to one of the applications 215a-n via the messaging system 210, the first message may have an application-level dependency on a second message arriving in the distributed system 217. If the second message does not arrive prior to first message, then the application attempting to process the first message generates an error. In this manner, the first message has a dependency relationship with the second message because processing the first message is dependent upon receipt of the second message in the distributed computing system 217. In embodiments, the learning module 240 analyzes data associated with the messages to learn such dependency relationships between types of messages processed by the applications 215a-n. In one example, the learning comprises generating an artificial intelligence model based on message arrival logs and message error logs in the distributed computing system 217. In another example, the learning comprises: identifying an unsuccessful attempt to process a first historic message of the first type of message by one of the applications 215a-n in the distributed computing system; identifying a successful retry attempt to process the first historic message by the one of the applications 215a-n in the distributed computing system; and in response to determining a second historic message of a second type of message arrived in the distributed computing system after the unsuccessful attempt and prior to the successful retry attempt, creating a dependency relationship between the first type of message and the second type of message.

In accordance with aspects of the invention, the learning module 240 is further configured to generate a dependency graph associated with a first type of message, wherein the dependency graph includes respective ones of the dependency relationships associated with the first type of message. In embodiments, the dependency relationships included in the dependency graph comprise relationships in which processing the message of the first type of message is dependent upon receipt of one or more additional messages in the distributed computing system. In embodiments, the dependency graph comprises a directed graph in which nodes on the directed graph are representative of messages in an event stream and edges connecting the nodes are representative of dependencies between the messages.

In accordance with aspects of the invention, the handling module 245 is configured to delay a retry of processing a message of the first type of message until all the dependency relationships included in the dependency graph are satisfied. In embodiments, in response to one of the applications 215a-n generating an error when processing a message, the handling module 245 puts the message in a queue, obtains the dependency graph for this type of message, and monitors other messages in the distributed computing system 217 to determine whether all the dependencies included in the dependency graph for this type of message are satisfied. This may comprise, for example, identifying one or more types of messages associated with one or more dependency relationships included in the dependency graph, and determining whether messages of these identified one or more types have been received in the distributed computing system 217 prior to the message that caused the error. In the event that all the dependency relationships included in the dependency graph are not satisfied, then the handling module 245 holds the message in the queue and continues to monitor other messages in the distributed computing system 217. When the handling module 245 determines that all the dependency relationships included in the dependency graph are satisfied, then the handling module 245 releases the message from the queue for a retry attempt by the one of the applications 215a-n that previously generated the error for this message. In this manner, the retry processing is optimized based on dependency relationships for the particular message rather than being repeated at a predefined time interval.

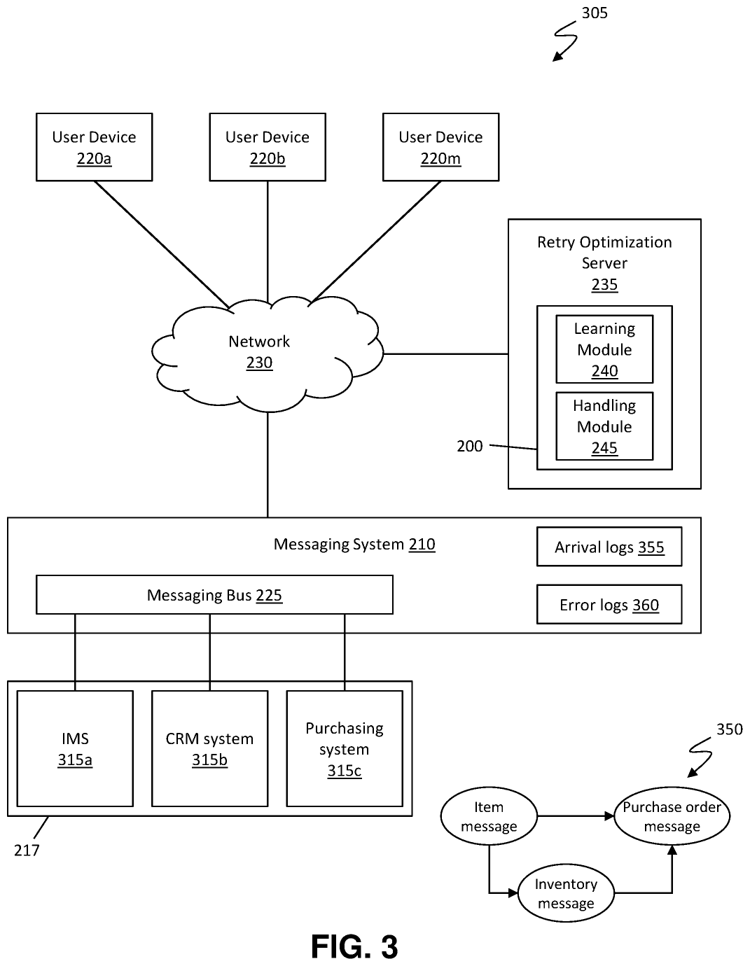

FIG. 3 shows a block diagram of an exemplary environment 305 that illustrates aspects of an exemplary use case in accordance with aspects of the invention. The environment 305 includes the messaging system 210, user devices 220a-m, and retry optimization server 235 as in FIG. 2. Inventory management system (IMS) 315a, customer relationship management (CRM) system 315b, and purchasing system 315c in FIG. 3 correspond to instances of applications 215a-n of FIG. 2. The IMS 315a, CRM system 315b, and purchasing system 315c may be used by an enterprise to provide inventory and purchasing management for the enterprise.

In the example shown in FIG. 3, when a new item is to be added to the inventory system of the enterprise, one of the user devices 320a-m sends an item message to the IMS 315a via the messaging bus 325 of the MoM system. The item message defines a new item to be added to the inventory system and is processed by the IMS 315a to update the inventory system to include this new item. During normal operation, after the item is added to the inventory system, one of the user devices 320a-m sends an inventory message to the CRM system 315b to populate a quantity of this item in inventory. During normal operation, after the item is added to the inventory system and after the quantity of the item in inventory is populated, one of the user devices 320a-m sends a purchase order message to the purchasing system 315c, where the purchase order message indicates a purchase of one or more of the quantity of the item in inventory. In this example, processing of the purchase order message by the purchasing system 315c depends on the item message and the inventory message having already been received and processed by the IMS 315a and the CRM system 315b, respectively. However, the respective messages do not always arrive in the this order. As a result, if the purchasing system 315c receives and attempts to process the purchase order message before the arrival and processing of the item message and/or the inventory message, then the purchasing system 315c generates an error for the purchase order message.

With continued reference to the exemplary use case of FIG. 3, the learning module 240 is configured to learn the dependency relationships between the purchase order message, the item message, and the inventory message, and to convert the learned dependency relationships into a dependency graph 350. As shown in FIG. 3, the dependency graph 350 may comprise a directed graph in which nodes on the directed graph are representative of messages in an event stream (i.e., the purchase order message, the item message, and the inventory message in this example), and in which edges connecting the nodes are representative of dependencies between the messages. In embodiments, the learning module 240 learns the dependency relationships by analyzing message arrival logs 355 and message error logs 360 of the messaging system 210. The message arrival logs 355 contain information that identifies messages that arrive in the messaging system 210 and what time those message arrived at one of the applications such as IMS 315a, CRM 315b, and purchasing system 315c. The message error logs 360 contain information that identifies a message that caused an error, which application generated the error for the message, and what time the application generated the error for the message.

With further reference to the exemplary use case of FIG. 3, in response to the purchasing system 315c generating an error for the purchase order message, the handling module 245 is configured to delay retry processing of the purchase order message by the purchasing system 315c until all the dependency relationships in the dependency graph 350 have been satisfied. In this example, the handling module 245 performs this by receiving the purchase order message from the purchasing system 315c, holding the purchase order message in a queue until such time as the item message and the inventory message have been received and processed, and then releasing the purchase order message back to the purchasing system 315c for the purchasing system 315c to retry processing of the purchase order message.

In some embodiments, the learning the dependency relationships comprises generating an artificial intelligence (AI) model based on message arrival logs and message error logs in the distributed computing system. As described previously, the message arrival logs contain information that identifies all historic (i.e., past) messages that arrived in the messaging system, a type of each message, and what time each message arrived at one of the applications. As described previously, the message error logs contain information that identifies a message that caused an error, which application generated the error when processing the message, what time the application generated the error for the message, and whether the error was generated during the initial processing or retry processing of the message.

In embodiments, the learning module 240 uses the information from the message arrival logs and message error logs to populate a database for different message types, wherein the database includes information that indicates success or failure of processing retries of a first type of message and whether a not a second type of message arrived between a failed retry and a successful retry of the first type of message. In embodiments, the learning module 240 uses the database to generate a training dataset for respective types of message, wherein the training dataset comprises: a first binary value (e.g., an X value) that indicates whether a message of a second type arrived before a retry of a message of a first type (e.g., 1 if true, 0 if false); and a second binary value (e.g., a Y value) that indicates whether the retry of the message of the first type succeeded on the next attempt (e.g., 1 if true, 0 if false). In embodiments, the training dataset includes an (X, Y) value pair for all messages of the first message type and the second message type, and the learning module 240 uses an AI learning algorithm with the training dataset to learn an AI model that predicts a value of Y for a given value of X for message of the types. The AI model may comprise, for example and without limitation, a decision tree, a support vector machine, or a neural network. In accordance with aspects of the invention, the properties of the AI model (e.g. weights on a decision tree, or attention weights on a neural network/transformer) indicate whether successful retry depends on the arrival of a message of a particular type. In implementations, the messages with higher weights for predicting the Y value are included in the dependency graph. In some embodiments, weights are added to the edges of the dependency graph.

In further embodiments, the learning module 240 is configured to update the AI model based on the success or failure of a retry attempt to process a message. For example, in response to a retry attempt of processing a message of a first type, the learning module 240 may update the dataset for this type of message with a new (X, Y) value pair based on this retry attempt, and the learning module may re-learn the AI model using the updated dataset. In this manner, the learning module 240 may be configured to update the AI model based on a successful retry attempt to process a message of a first type of message or an unsuccessful retry attempt to process the message of the first type of message.

In some embodiments, the learning the dependency relationships comprises the learning module 240 analyzing the message arrival logs and message error logs to: identify an unsuccessful attempt to process a first historic message of a first type of message by one of the applications in the distributed computing system; identify a successful retry attempt to process the first historic message by the one of the applications in the distributed computing system; and in response to determining a second historic message of a second type of message arrived in the distributed computing system after the unsuccessful attempt and prior to the successful retry attempt, create a dependency relationship between the first type of message and the second type of message. In this manner, by analyzing when a second type of message arrived relative to the unsuccessful and successful retry attempts of a first type of message, the learning module 240 may determine whether the first type of message has a dependency on the second type of message. For example, if a retry attempt of a first type of message fails before a second type of message arrives, and if a retry attempt of the first type of message succeeds after the second type of message arrives, then the learning module 240 may infer that the first message has a dependency relationship on the second type of message. Conversely, if a retry attempt of a first type of message fails before a second type of message arrives, and if a retry attempt of the first type of message fails after the second type of message arrives, then the learning module 240 may infer that the first message does not have a dependency relationship on the second type of message. By analyzing thousands of such instances from historic messages in the messaging system (e.g., via the message arrival logs and message error logs), the learning module 240 may learn with confidence which types of messages have a dependency relationship with respective other types of messages.

In embodiments, the learning module 240 may generate different respective dependency graphs for different respective types of messages. In this manner, when an application generates an error in processing a message, the handling module 245 obtains the dependency graph associated with the type of message that caused the error.

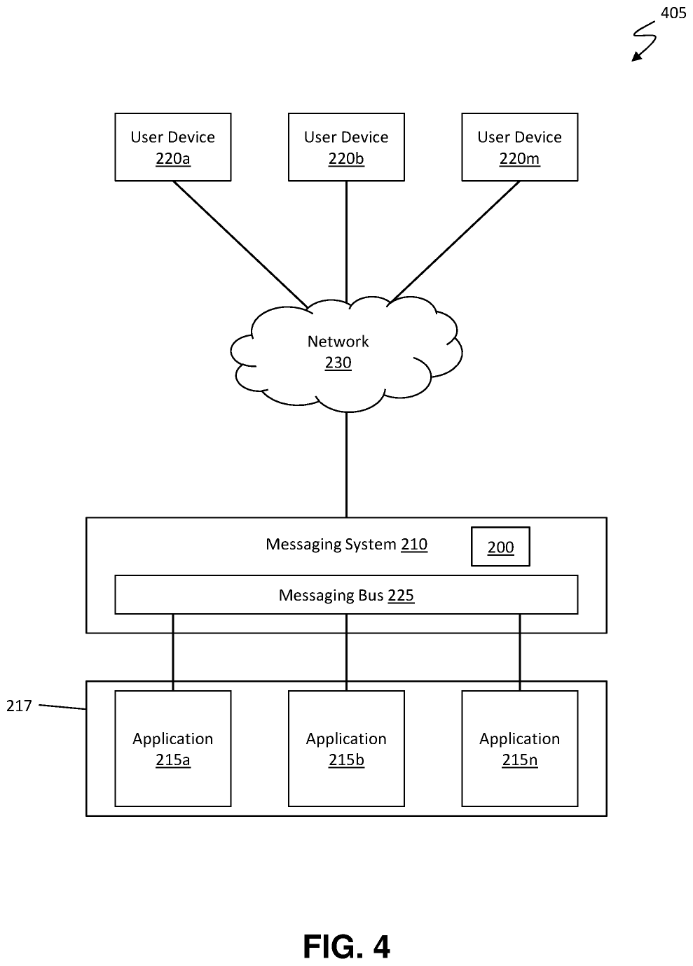

FIG. 4 shows a block diagram of an exemplary environment 405 in accordance with aspects of the invention. The environment 405 includes the messaging system 210, applications 215a-n, and user devices 220a-m as in FIG. 2. In the embodiment shown in FIG. 4, the retry optimization code of block 200 is executed by the messaging system 210 rather than by a separate retry optimization server 235 as in FIG. 2. Although not shown, the retry optimization code of block 200 in FIG. 4 may include the learning module 240 and the handling module 245 that operate in a similar manner as described with respect to FIG. 2.

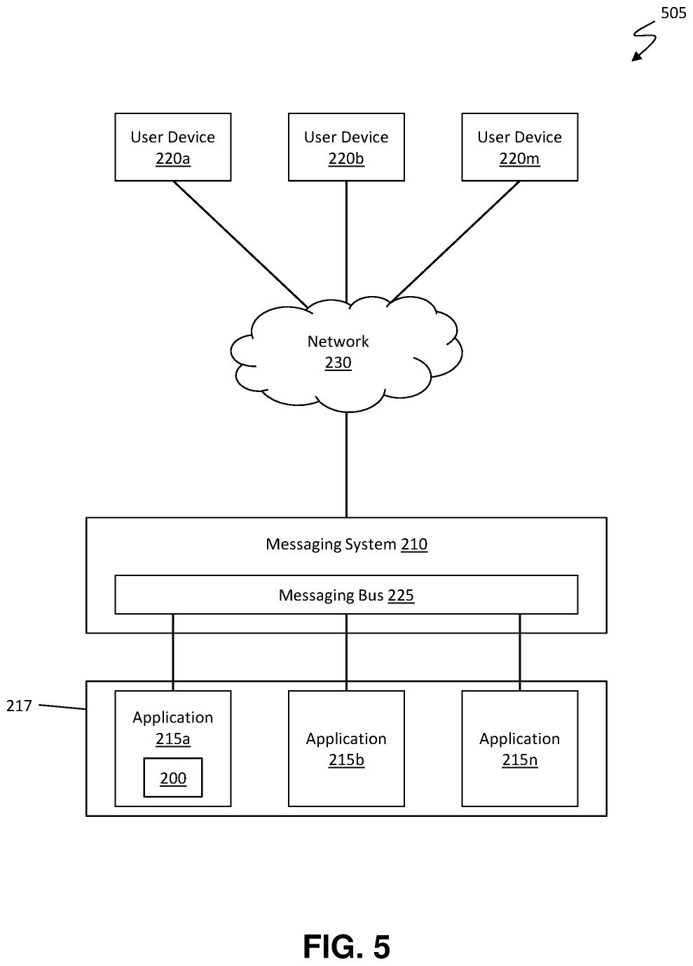

FIG. 5 shows a block diagram of an exemplary environment 505 in accordance with aspects of the invention. The environment 505 includes the messaging system 210, applications 215a-n, and user devices 220a-m as in FIG. 2. In the embodiment shown in FIG. 5, the retry optimization code of block 200 is executed by one of the applications 215a-n in the distributed computing system rather than by a separate retry optimization server 235 as in FIG. 2. Although not shown, the retry optimization code of block 200 in FIG. 5 may include the learning module 240 and the handling module 245 that operate in a similar manner as described with respect to FIG. 2.

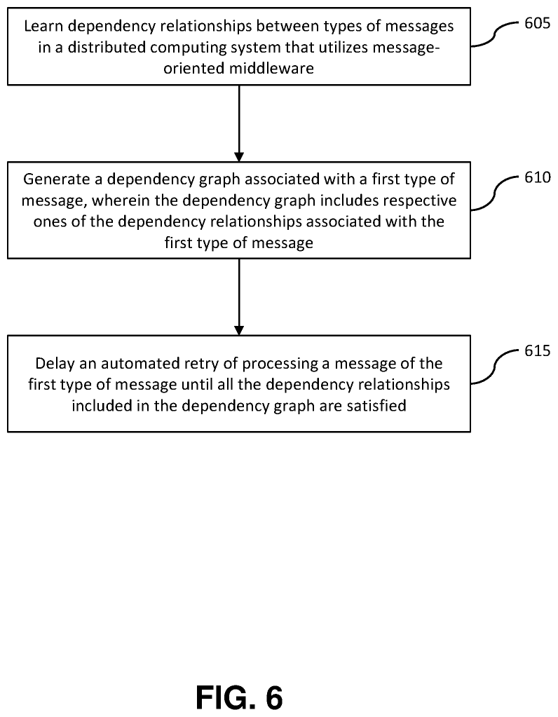

FIG. 6 shows a flowchart of an exemplary method in accordance with aspects of the present invention. Steps of the method may be carried out in the environment of FIG. 2 and are described with reference to elements depicted in FIG. 2. Steps of the method may alternatively be carried out in the environments of FIGS. 4 and 5, respectively.

At step 605, the system learns dependency relationships between types of messages in a distributed computing system that utilizes message-oriented middleware. In embodiments, and as described with respect to FIGS. 2-3, the learning module 240 learns the dependency relationships by analyzing message arrival logs and message error logs.

At step 610, the system generates a dependency graph associated with a first type of message, wherein the dependency graph includes respective ones of the dependency relationships associated with the first type of message. In embodiments, and as described with respect to FIGS. 2-3, the learning module 240 generates a dependency graph such as dependency graph 350.

At step 610, the system delays a retry of processing a message of the first type of message until all the dependency relationships included in the dependency graph are satisfied. In embodiments, and as described with respect to FIGS. 2-3, the handling module 245 delays the retry of processing a message by holding the message in a queue until all the dependency relationships included in the dependency graph are satisfied.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
learning dependency relationships between types of messages in a distributed computing system that utilizes message-oriented middleware;
generating a dependency graph associated with a first type of message, wherein the dependency graph includes respective ones of the dependency relationships associated with the first type of message; and
delaying an automated retry of processing a message of the first type of message until all the dependency relationships included in the dependency graph are satisfied.

2. The computer-implemented method of claim 1, wherein the dependency relationships included in the dependency graph comprise relationships in which processing the message of the first type of message is dependent upon receipt of one or more additional messages in the distributed computing system.

3. The computer-implemented method of claim 1, wherein the learning comprises generating an artificial intelligence model based on message arrival logs and message error logs in the distributed computing system.

4. The computer-implemented method of claim 3, further comprising updating the artificial intelligence model based on a successful retry attempt to process the message of the first type of message or an unsuccessful retry attempt to process the message of the first type of message.

5. The computer-implemented method of claim 1, wherein the learning comprises:
identifying an unsuccessful attempt to process a first historic message of the first type of message by an application in the distributed computing system;
identifying a successful retry attempt to process the first historic message by the application in the distributed computing system; and
in response to determining a second historic message of a second type of message arrived in the distributed computing system after the unsuccessful attempt and prior to the successful retry attempt, creating a dependency relationship between the first type of message and the second type of message.

6. The computer-implemented method of claim 1, wherein the dependency graph comprises a directed graph in which nodes on the directed graph are representative of messages in an event stream and edges connecting the nodes are representative of dependencies between the messages.

7. The computer-implemented method of claim 1, wherein the learning, the generating, and the delaying are performed by an application in the distributed computing system.

8. The computer-implemented method of claim 1, wherein the learning, the generating, and the delaying are performed by the message-oriented middleware.

9. The computer-implemented method of claim 1, wherein the learning, the generating, and the delaying are performed by a computing node that is separate from the message-oriented middleware and applications in the distributed computing system.

10. The computer-implemented method of claim 9, further comprising receiving the message of the first type of message from an application in the distributed computing system with an indication of an error, wherein the delaying comprises:
while holding the message of the first type of message in a queue, determining whether all the dependency relationships included in the dependency graph are satisfied; and
in response to determining all the dependency relationships included in the dependency graph are satisfied, sending the message of the first type of message back to the application in the distributed computing system for the retry of processing the message of the first type of message.

11. A computer program product comprising one or more computer readable storage media having program instructions collectively stored on the one or more computer readable storage media, the program instructions executable to:
learn dependency relationships between types of messages in a distributed computing system that utilizes message-oriented middleware;
generate a dependency graph associated with a first type of message, wherein the dependency graph includes respective ones of the dependency relationships associated with the first type of message; and
delay an automated retry of processing a message of the first type of message until all the dependency relationships included in the dependency graph are satisfied.

12. The computer program product of claim 11, wherein the dependency relationships included in the dependency graph comprise relationships in which processing the message of the first type of message is dependent upon receipt of one or more additional messages in the distributed computing system.

13. The computer program product of claim 11, wherein:
the learning comprises generating an artificial intelligence model based on message arrival logs and message error logs in the distributed computing system; and
the program instructions are executable to update the artificial intelligence model based on a successful retry attempt to process the message of the first type of message or an unsuccessful retry attempt to process the message of the first type of message.

14. The computer program product of claim 11, wherein the learning comprises:
identifying an unsuccessful attempt to process a first historic message of the first type of message by an application in the distributed computing system;
identifying a successful retry attempt to process the first historic message by the application in the distributed computing system; and
in response to determining a second historic message of a second type of message arrived in the distributed computing system after the unsuccessful attempt and prior to the successful retry attempt, creating a dependency relationship between the first type of message and the second type of message.

15. The computer program product of claim 11, wherein the dependency graph comprises a directed graph in which nodes on the directed graph are representative of messages in an event stream and edges connecting the nodes are representative of dependencies between the messages.

16. A system comprising:
a processor set, one or more computer readable storage media, and program instructions collectively stored on the one or more computer readable storage media, the program instructions executable to:
learn dependency relationships between types of messages in a distributed computing system that utilizes message-oriented middleware;
generate a dependency graph associated with a first type of message, wherein the dependency graph includes respective ones of the dependency relationships associated with the first type of message; and
delay an automated retry of processing a message of the first type of message until all the dependency relationships included in the dependency graph are satisfied.

17. The system of claim 16, wherein the dependency relationships included in the dependency graph comprise relationships in which processing the message of the first type of message is dependent upon receipt of one or more additional messages in the distributed computing system.

18. The system of claim 16, wherein:
the learning comprises generating an artificial intelligence model based on message arrival logs and message error logs in the distributed computing system; and
the program instructions are executable to update the artificial intelligence model based on a successful retry attempt to process the message of the first type of message or an unsuccessful retry attempt to process the message of the first type of message.

19. The system of claim 16, wherein the learning comprises:
identifying an unsuccessful attempt to process a first historic message of the first type of message by an application in the distributed computing system;
identifying a successful retry attempt to process the first historic message by the application in the distributed computing system; and
in response to determining a second historic message of a second type of message arrived in the distributed computing system after the unsuccessful attempt and prior to the successful retry attempt, creating a dependency relationship between the first type of message and the second type of message.

20. The system of claim 16, wherein the dependency graph comprises a directed graph in which nodes on the directed graph are representative of messages in an event stream and edges connecting the nodes are representative of dependencies between the messages.
